(19) United States
(12) Patent Application Publication
(10) Pub. No.: US 2026/0279897 A1
(43) Pub. Date: Sep. 17, 2026

(54) FLUORIDE ION CONDUCTOR AND FLUORIDE ION BATTERY

(71) Applicants: TOYOTA JIDOSHA KABUSHIKI KAISHA, Toyota-shi (JP); The Ritsumeikan Trust, Kyoto (JP)

(72) Inventors: Hidenori MIKI, Hiratsuka-shi (JP); Takeshi TOJIGAMORI, Sunto-gun (JP); Yuki ORIKASA, Kusatsu-shi (JP); Chengchao ZHONG, Kusatsu-shi (JP); Honoka OURA, Kusatsu-shi (JP)

(73) Assignees: TOYOTA JIDOSHA KABUSHIKI KAISHA, Toyota-shi (JP); The Ritsumeikan Trust, Kyoto (JP)

(21) Appl. No.: 19/563,575

(22) Filed: Mar. 11, 2026

(30) Foreign Application Priority Data
Mar. 13, 2025 (JP) 2025-040451

(51) Int. Cl. H01M 10/0562; H01M 10/054

(52) U.S. Cl. CPC H01M 10/0562; H01M 10/054; H01M 2300/008

(57) ABSTRACT

The present disclosure provides a fluoride ion conductor with improved ionic conductivity and a fluoride ion battery containing such a fluoride ion conductor. A fluoride ion conductor of the present disclosure contains lanthanum, strontium, fluorine, and sulfur and has a double honeycomb structure. A fluoride ion battery of the present disclosure has a positive electrode active material layer, a solid electrolyte layer, and a negative electrode active material layer in this order, and at least one selected from the positive electrode active material layer, the solid electrolyte layer, and the negative electrode active material layer contains the fluoride ion conductor of the present disclosure.

### TECHNICAL FIELD

The present disclosure relates to a fluoride ion conductor and a fluoride ion battery.

### BACKGROUND

As disclosed in PTL 1, as well as NPLs 1 and 2, various materials have been developed as fluoride ion conductors for use in fluoride ion batteries.

For example, PTL1 discloses a solid electrolyte having fluoride ionic conductivity, which has a crystal phase represented by M₃F₄S₂ (where M is one, or two or more types of metal).

NPL 1 discloses a fluoride ion conductor having a double honeycomb structure represented by La_{2.7}Ba_{6.3}F_{8.7}S₆.

NPL 2 discloses polycrystalline tysonite type fluorides represented by La_{1-y}Ba_{y}F_{3-y} (0≤y≤0.15) as solid electrolytes for fluoride ion batteries.

### CITATION LIST

### Patent Literature

[PTL 1] Japanese Unexamined Patent Publication (Kokai) No. 2021-068664

### Non Patent Literature

[NPL 1] Shintaro Tachibana et al., “Fluorosulfide La2.7Ba6.3F8.7S6 with a double-layer honeycomb structure enabling fluoride-ion conduction”, Journal of Materials Chemistry A, 2024, vol. 12, pp. 14419 to 14425
[NPL 2] Carine Rongeat et al., “Solid electrolytes for fluoride ion batteries: ionic conductivity in polycrystalline tysonite-type fluorides”, 2014, vol. 6, No. 3, pp. 2103 to 2110

### SUMMARY

### Technical Problem

A fluoride ion conductor can be further improved in terms of ionic conductivity.

The object of the present disclosure is to provide a fluoride ion conductor with improved ionic conductivity and a fluoride ion battery containing such a fluoride ion conductor.

The present inventors have found that the above-described issues can be solved by the following means.

### <Aspect 1>

A fluoride ion conductor,
wherein the fluoride ion conductor contains lanthanum, strontium, fluorine, and sulfur, and
wherein the fluoride ion conductor has a double honeycomb structure.

### <Aspect 2>

The fluoride ion conductor according to aspect 1, wherein the fluoride ion conductor is represented by a compositional formula, La₁₋ₓSr₂₊ₓF₃₋ₓS₂.

### <Aspect 3>

The fluoride ion conductor according to aspect 2, wherein x in the compositional formula satisfies 0≤x≤0.5.

### <Aspect 4>

The fluoride ion conductor according to aspect 3, wherein x in the compositional formula satisfies 0.2≤x≤0.4.

### <Aspect 5>

A fluoride ion battery, including, in this order, a positive electrode active material layer, a solid electrolyte layer, and a negative electrode active material layer, wherein at least one selected from the positive electrode active material layer, the solid electrolyte layer, and the negative electrode active material layer contains the fluoride ion conductor according to any one of aspects 1 to 4.

### Advantageous Effects of Invention

According to the present disclosure, it is possible to provide a fluoride ion conductor with improved ionic conductivity, and a fluoride ion battery including such a fluoride ion conductor.

### BRIEF DESCRIPTION OF DRAWINGS

FIG. 1 is a diagram illustrating a crystal structure of a fluoride ion conductor of the present disclosure.

FIG. 2 is a schematic cross-sectional view illustrating an example of a fluoride ion battery of the present disclosure.

FIG. 3 presents XRD patterns of fluoride ion conductors of Examples 1 to 6 and SrS.

FIG. 4 is a graph indicating a relationship between a temperature and ionic conductivity of fluoride ion conductors (φ10 mm) of Examples 1 and 2 and Comparative Example 1.

FIG. 5 is a graph indicating a relationship between a temperature and ionic conductivity of the fluoride ion conductors (φ5 mm) of Examples 2 to 6 and Comparative Example 1.

### DESCRIPTION OF EMBODIMENTS

Hereinafter, embodiments of the present disclosure will be described in detail. However, it should be noted that the present disclosure is not limited to the following embodiments, and can be variously modified within the scope thereof.

### <<Fluoride Ion Conductor>>

A fluoride ion conductor of the present disclosure contains lanthanum, strontium, fluorine, and sulfur and has a double honeycomb structure.

The present inventors have found that the fluoride ion conductor represented by the above-described compositional formula has improved ionic conductivity. The reason for this is not intended to be bound by any theory, but is presumed to be as follows.

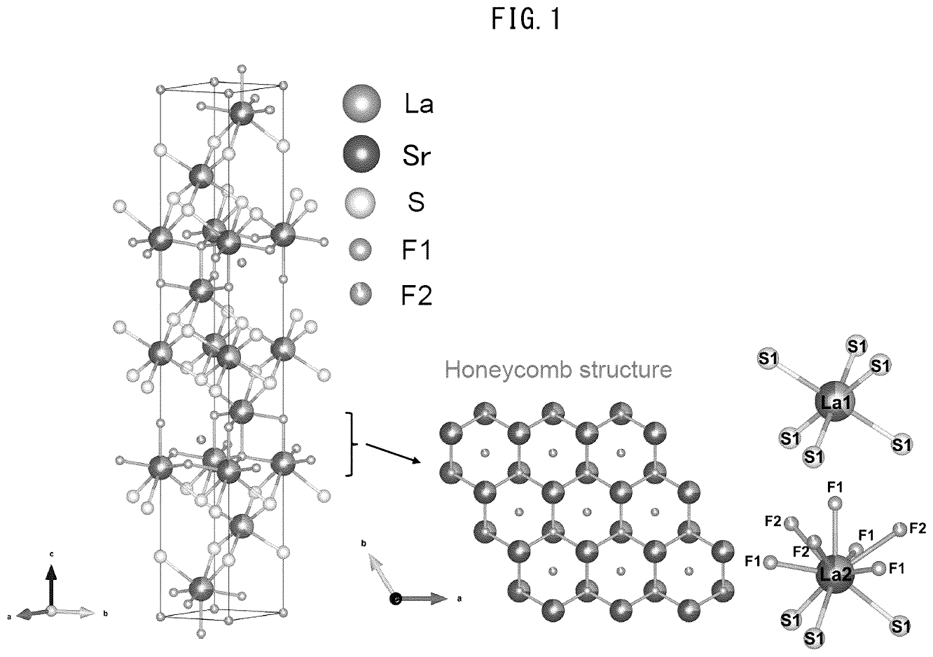

Specifically, as illustrated in FIG. 1, the fluoride ion conductor of the present disclosure has a double honeycomb structure, similarly to the fluoride ion conductor represented by La_{2.7}Ba_{6.3}F_{8.7}S₆ disclosed in the above-mentioned NPL 2. In the context of the present disclosure, a “double honeycomb structure” means a structure having two layers of honeycomb structure within a unit cell. Fluorine (F) vacancies are present in these honeycomb structure portions, and fluoride ions can diffuse through the F vacancies. It is assumed that this improves the ionic conductivity.

On the other hand, the composition of the fluoride ion conductor of the present disclosure is a composition in which barium (Ba) of NPL 2 is substituted with strontium (Sr). It is assumed that a two-dimensional F-F distance, i.e., the length of the diffusion path of fluoride ions which are carrier ions, is shortened by substituting Ba with Sr in this manner. It is assumed that this improves the ionic conductivity. In the fluoride ion conductor of the present disclosure, the two-dimensional F-F distance is shortened, apparently because the ionic radius of Sr is smaller than the ionic radius of Ba, and thus the crystal lattice of the fluoride ion conductor is reduced.

The fluoride ion conductor of the present disclosure having such improved ionic conductivity can function as a solid electrolyte for a fluoride ion battery.

The fluoride ion conductor of the present disclosure may be represented by a compositional formula La₁₋ₓSr₂₊ₓF₃₋ₓS₂.

In the compositional formula, x may satisfy 0≤x≤1.0, 0≤x≤0.9, 0≤x≤0.8, 0≤x≤0.7, 0≤x≤0.6, 0≤x≤0.5, and 0≤x<0.5. x may satisfy 0.1≤x<0.5, 0.2≤x≤0.5, or 0.3≤x≤0.5. In addition, x may satisfy 0≤x≤0.4, 0.1≤x≤0.4, 0.2≤x<0.4, or 0.3≤x<0.4

x may be 0 or more, more than 0, 0.1 or more, 0.2 or more, 0.3 or more, 0.4 or more, or 0.5 or more, and may be 1.0 or less, 0.9 or less, 0.8 or less, 0.7 or less, 0.6 or less, 0.5 or less, less than 0.5, or 0.4 or less. This can effectively improve the ionic conductivity.

When x is 0.2 or more, the ionic conductivity can be particularly effectively improved. The reason for this is not intended to be bound by any theory, but is presumed to be as follows. Specifically, by changing the value of x, F vacancies corresponding to the value of x can be introduced into the honeycomb structure portions of the fluoride ion conductor. This is believed to allow fluoride ions to diffuse through the F vacancies present at an appropriate proportion, thus effectively improving the ionic conductivity.

When x is less than 0.5, single-phase La₁₋ₓSr₂₊ₓF₃₋ₓS₂ is likely to be obtained in the crystal phase. It is preferable that the single-phase La₁₋ₓSr₂₊ₓF₃₋ₓS₂ be obtained in the crystal phase, from the viewpoint of improving the ionic conductivity.

A method for producing the fluoride ion conductor of the present disclosure is not particularly limited. For example, the fluoride ion conductor of the present disclosure can be produced by a method including the following steps:
(a) mixing lanthanum fluoride (LaF₃), strontium fluoride (SrF₂), and strontium sulfide (SrS) as raw materials to prepare a raw material mixture;
(b) forming a pellet of the raw material mixture; and
(c) heat-treating the pellet.

In the step (a), the molar ratio of the raw materials can be appropriately set in consideration of the desired composition ratio of the fluoride ion conductor, and the like.

An amount of LaF₃ used may be from 0.5 mol % to 1.0 mol %.

An amount of SrF₂ used may be from 0 mol % to 0.5 mol %.

SrS is highly volatile, and thus an amount of SrS used may be excessive with respect to the desired composition ratio. For example, the amount of SrS used may be 10 mol % in excess with respect to the desired composition ratio, and in this case, the amount of SrS used may be 2.2 mol % to 2.8 mol %. In the produced fluoride ion conductor, unvolatilized SrS may remain, and this may cause a change in composition of the fluoride ion conductor. Specifically, the molar ratio of F and S may be different by 5 to 10% from that of the particularly desired fluoride ion conductor represented by the compositional formula La₁₋ₓSr₂₊ₓF₃₋ₓS₂.

The method of mixing the raw materials is not particularly limited, and examples thereof include a method of mixing the raw materials in a mortar. The mixing conditions such as the mixing time are not particularly limited.

In the step (b), the method of forming a pellet of the raw material mixture is not particularly limited, and a common method in a solid phase synthesis method can be adopted.

In the step (c), the heat treatment conditions such as a heat treatment temperature and a heat treatment time when the pellet is heat-treated are not particularly limited. The heat treatment temperature may be, for example, 500° C. or higher, 700° C. or higher, 900° C. or higher, or 1000° C. or higher, and may be 2000° C. or lower, 1500° C. or lower, 1300° C. or lower, 1200° C. or lower, or 1100° C. or lower. The heat treatment time may be, for example, 1 hour or longer, 5 hours or longer, 10 hours or longer, 20 hours or longer, 30 hours or longer, or 40 hours or longer, and may be 100 hours or shorter, 80 hours or shorter, 60 hours or shorter, 50 hours or shorter, or 40 hours or shorter.

The fluoride ion conductor of the present disclosure can be produced by a method further including the following steps:
(d) grinding the heat-treated pellet to obtain a ground product;
(e) forming a pellet of the ground product; and
(f) heat-treating the pellet.

It should be noted that in a case where the method for producing a fluoride ion conductor of the present disclosure further includes steps (d) to (f), the steps (a) to (f) can be represented as the following (a′) to (f):
(a′) mixing LaF₃, SrF₂, and SrS as raw materials to prepare a raw material mixture;
(b′) pelletizing the raw material mixture to form a first pellet;
(c′) heat-treating the first pellet;
(d′) grinding the heat-treated first pellet to obtain a ground product;
(e′) pelletizing the ground product to form a second pellet; and
(f) heat-treating the second pellet.

As for steps (a′) to (c′), reference can be made to the aforementioned description regarding steps (a) to (c).

In step (d′), the method of grinding the heat-treated first pellet is not particularly limited, and a common method can be adopted.

In step (e′), the method of pelletizing the ground product is not particularly limited, and a common method in the solid phase synthesis method can be adopted.

The method for producing a fluoride ion conductor of the present disclosure may further include, between step (d′) and step (e′), mixing the ground product to obtain a ground mixture. The method of mixing the ground product is not particularly limited, and may be, for example, the same method as the method in step (a′) or a different method.

In step (f), the heat treatment conditions are not particularly limited, and may be, for example, the same as or different from, particularly the same as, the heat treatment conditions in step (c′).

Steps (d) to (f) ((d′) to (f)) may be repeated until the fluoride ion conductor of the present disclosure is sufficiently prepared. In this case, the “first” in steps (d′) to (f) can be read as the “n-th”, and the “second” can be read as the “(n+1)-th”. n is not particularly limited, and may be, for example, 1 or more, and may be 4 or less, 3 or less, or 2 or less.

### <<Fluoride Ion Battery>>

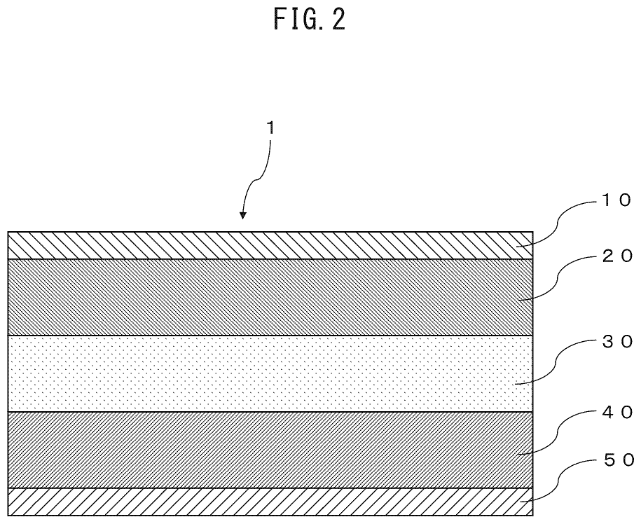

As illustrated in FIG. 2, a fluoride ion battery 1 of the present disclosure has a positive electrode active material layer 20, a solid electrolyte layer 30, and a negative electrode active material layer 40 in this order, and at least one selected from the positive electrode active material layer, the solid electrolyte layer, and the negative electrode active material layer contains the fluoride ion conductor of the present disclosure. In the fluoride ion battery 1 of the present disclosure, at least one selected from the positive electrode active material layer and the negative electrode active material layer may include the fluoride ion conductor of the present disclosure.

As illustrated in FIG. 2, the fluoride ion battery 1 of the present disclosure may have a positive electrode current collector layer 10, a positive electrode active material layer 20, a solid electrolyte layer 30, a negative electrode active material layer 40, and a negative electrode current collector layer 50 in this order.

The fluoride ion battery of the present disclosure may be a solid-state battery. It should be noted that in the present disclosure, the “solid-state battery” means a battery using at least a solid electrolyte as an electrolyte, and thus, the solid-state battery may use a combination of a solid electrolyte and a liquid electrolyte as an electrolyte. The solid-state battery of the present disclosure may be an all-solid-state battery, i.e., a battery using only a solid electrolyte as an electrolyte.

The fluoride ion battery may be a primary battery or a secondary battery, and may particularly be a secondary battery.

The fluoride ion battery may have, for example, a coin shape, a laminate shape (pouch shape), a cylindrical shape, or a square shape.

The fluoride ion battery can be produced by forming the respective layers by a dry method or a wet method.

The fluoride ion battery of the present disclosure may be suitably used in at least one vehicle selected from a hybrid vehicle (HEV), a plug-in hybrid vehicle (PHEV), and an electric vehicle (BEV), for example.

Hereinafter, each element that can constitute the fluoride ion battery of the present disclosure will be described. In particular, a case wherein the battery of the present disclosure is an all-solid-state fluoride ion secondary battery will be described as an example.

### <Positive Electrode Current Collector Layer>

Examples of the material of the positive electrode current collector layer include lead, stainless steel (SUS), aluminum, nickel, iron, titanium, platinum, and carbon.

### <Positive Electrode Active Material Layer>

The positive electrode active material layer contains a positive electrode active material. The positive electrode active material layer may contain the fluoride ion conductor of the present disclosure. In particular, in a case where the fluoride ion conductor of the present disclosure is not contained in any of the solid electrolyte layer and the negative electrode active material layer described below, the positive electrode active material layer contains the fluoride ion conductor of the present disclosure. In the positive electrode active material layer, the fluoride ion conductor of the present disclosure functions as a solid electrolyte, particularly as an ion conduction aid. The positive electrode active material layer may optionally contain a solid electrolyte other than the fluoride ion conductor of the present disclosure, a conductive additive, a binder, or the like.

### (Positive Electrode Active Material)

The positive electrode active material is normally fluorinated during charging and defluorinated during discharging. Examples of the positive electrode active material include an elemental metal, an alloy, a metal oxide, and fluorides thereof. Examples of the metal element contained in the positive electrode active material include Cu, Ag, Ni, Co, Pb, Mn, Au, Pt, Rh, V, Os, Ru, Fe, Cr, Bi, Nb, Sb, Ti, Sn, and Zn.

The shape, size, and the like of the positive electrode active material are not particularly limited, as long as it can function as a positive electrode active material of the fluoride ion battery.

The content of the positive electrode active material in the positive electrode active material layer is not particularly limited, and can be appropriately set in consideration of the desired capacity and the like of the battery.

### (Solid Electrolyte)

The solid electrolyte may be the fluoride ion conductor of the present disclosure, a solid electrolyte other than the fluoride ion conductor of the present disclosure, or a combination thereof. In a case where the positive electrode active material layer contains the fluoride ion conductor of the present disclosure, a solid electrolyte other than the fluoride ion conductor of the present disclosure may be contained or need not be contained.

For the fluoride ion conductor of the present disclosure, the aforementioned description can be referred to.

The solid electrolyte other than the fluoride ion conductor of the present disclosure is not particularly limited as long as it has fluoride ion conductivity. Examples of such a solid electrolyte include fluorides of lanthanoid elements such as La and Ce, fluorides of alkali metal elements such as Li, Na, K, Rb, and Cs, and fluorides of alkaline earth elements such as Ca, Sr, and Ba. The fluoride ion conductor may be a fluoride containing a combination of two or more of lanthanoid elements, alkali metal elements, and alkaline earth metal elements. The proportion of single-phase La₁₋ₓSr₂₊ₓF₃₋ₓS₂ in the total amount of the solid electrolyte may be 50 vol. % or more, 60 vol. % or more, 70 vol. % or more, 80 vol. % or more, or 90 vol. % or more, and may be 100 vol. %.

### (Conductive Additive)

The conductive additive is not particularly limited, as long as it has electron conductivity.

The conductive additive may be, for example, a carbon material, an elemental metal or a metal compound, or a combination thereof.

The carbon material may be, for example, carbon black such as acetylene black, Ketjen black, or furnace black; graphite powder; a fibrous carbon material such as vapor grown carbon fiber (VGCF); or a combination thereof.

The content of the conductive additive in the positive electrode active material layer is not particularly limited and can be appropriately set in consideration of desired electron conductivity and the like.

### (Binder)

The binder is not particularly limited, and may be, for example, a fluorine-based binder such as polyvinylidene fluoride (PVDF) or polytetrafluoroethylene (PTFE); a rubber-based binder such as styrene-butadiene rubber (SBR); or a combination thereof. The content of the binder in the positive electrode active material layer is not particularly limited, and can be appropriately set in consideration of a desired binding property and the like.

### <Solid Electrolyte Layer>

### (Solid Electrolyte)

The solid electrolyte layer contains a solid electrolyte. The solid electrolyte layer may contain the fluoride ion conductor of the present disclosure. In the solid electrolyte layer, the fluoride ion conductor of the present disclosure functions as a solid electrolyte. In particular, in a case where the fluoride ion conductor of the present disclosure is not contained in any of the positive electrode active material layer and the negative electrode active material layer described below, the solid electrolyte layer contains the fluoride ion conductor of the present disclosure. For the fluoride ion conductor of the present disclosure, the aforementioned description can be referred to.

In a case where the solid electrolyte layer contains the fluoride ion conductor of the present disclosure, a solid electrolyte other than the fluoride ion conductor of the present disclosure may be contained or need not be contained. For the solid electrolyte other than the fluoride ion conductor of the present disclosure, the aforementioned description can be referred to.

The proportion of single-phase La₁₋ₓSr₂₊ₓF₃₋ₓS₂ in the total amount of the solid electrolyte may be 50 vol. % or more, 60 vol. % or more, 70 vol. % or more, 80 vol. % or more, or 90 vol. % or more, and may be 100 vol. %.

The shape, size, and the like of each of the fluoride ion conductor of the present disclosure and the solid electrolyte other than the fluoride ion conductor of the present disclosure are not particularly limited, as long as they can function as a solid electrolyte of the fluoride ion battery.

The content of the solid electrolyte in the solid electrolyte layer is not particularly limited, and can be appropriately set in consideration of desired ionic conductivity and the like.

### (Binder)

The solid electrolyte layer may optionally contain a binder.

As regards the binder, the aforementioned description can be referred to.

### <Negative Electrode Active Material Layer>

The negative electrode active material layer contains a negative electrode active material. The negative electrode active material layer may contain the fluoride ion conductor of the present disclosure. In particular, when the fluoride ion conductor of the present disclosure is not contained in either of the positive electrode active material layer and the solid electrolyte layer, the negative electrode active material layer contains the fluoride ion conductor of the present disclosure. In the negative electrode active material layer, the fluoride ion conductor of the present disclosure functions as a solid electrolyte, particularly as an ion conduction aid. The negative electrode active material layer may optionally contain a solid electrolyte other than the fluoride ion conductor of the present disclosure, a conductive additive, a binder, or the like.

### (Negative Electrode Active Material)

The negative electrode active material is usually defluorinated during charging and fluorinated during discharging. The negative electrode active material may be, for example, at least one selected from an elemental metal, an alloy, a metal oxide, a metal fluoride, a carbon material, and a polymer material. The metal element constituting the negative electrode active material may be, for example, at least one selected from La, Ca, Al, Eu, Li, Si, Ge, Sn, In, V, Cd, Cr, Fe, Zn, Ga, Ti, Nb, Mn, Yb, Zr, Sm, Ce, Mg, and Pb. The carbon material constituting the negative electrode active material may be, for example, at least one selected from graphite, coke, and carbon nanotubes. The polymer material constituting the negative electrode active material may be at least one selected from polyaniline, polypyrrole, polyacetylene, and polythiophene.

The shape, size, and the like, of the negative electrode active material are not particularly limited, as long as it can function as the negative electrode active material of the fluoride ion battery.

The content of the negative electrode active material in the negative electrode active material layer is not particularly limited, and can be appropriately set in consideration of the desired capacity and the like of the battery.

### (Solid Electrolyte)

The solid electrolyte may be the fluoride ion conductor of the present disclosure, a solid electrolyte other than the fluoride ion conductor of the present disclosure, or a combination thereof. In a case where the negative electrode active material layer includes the fluoride ion conductor of the present disclosure, a solid electrolyte other than the fluoride ion conductor of the present disclosure may be contained or need not be contained.

For the fluoride ion conductor of the present disclosure and the solid electrolyte other than the fluoride ion conductor of the present disclosure, the aforementioned description can be referred to.

The proportion of single-phase La₁₋ₓSr₂₊ₓF₃₋ₓS₂ in the total amount of the solid electrolyte may be 50 vol. % or more, 60 vol. % or more, 70 vol. % or more, 80 vol. % or more, or 90 vol. % or more, and may be 100 vol. %.

### (Conductive Additive and Binder)

For the conductive additive and the binder, the aforementioned description can be referred to.

### <Negative Electrode Current Collector Layer>

Examples of the material of the negative electrode current collector layer include stainless steel (SUS), copper, nickel, iron, titanium, platinum, and carbon.

The shape of each of the layers is not particularly limited, and may be, for example, a sheet shape having a substantially flat surface.

The thickness of each of the layers is not particularly limited and can be appropriately adjusted depending on the configuration of the battery.

The fluoride ion battery of the present disclosure may further have a configuration other than the above.

### EXAMPLES

### Example 1

### <Synthesis of Fluoride Ion Conductor>

Lanthanum fluoride (LaF₃), strontium fluoride (SrF₂), and strontium sulfide (SrS) as raw materials were weighed to have a molar ratio of LaF₃:SrF₂:SrS=0.5:0.5:2.2 and mixed in a mortar to obtain a raw material mixture. Since SrS is highly volatile, the amount of SrS used was set to 10 mol % excess based on the desired composition ratio.

The obtained raw material mixture was pelletized by a common method in a solid phase synthesis method to form a first pellet.

The obtained first pellet was heat-treated at 1050° C. for 40 hours under vacuum.

After the surface of the sample after the heat treatment was polished, the heat-treated first pellet was ground by a common method to obtain a ground product.

0.45 g of the obtained ground product was pelletized to have a size of @10 mm by the common method in the solid phase synthesis method to form a second pellet of φ10 mm. Further, 0.24 g of the obtained ground product was pelletized to have a size of φ5 mm by the common method in the solid phase synthesis method to form a second pellet of @5 mm.

The obtained second pellet was sintered by heat treatment at 1050° C. for 40 hours under vacuum. Thus, a fluoride ion conductor represented by the compositional formula La_{0.5}Sr_{2.5}F_{2.5}S₂ was obtained.

All of the above-described operations were conducted under an inert atmosphere.

### Example 2

A fluoride ion conductor was obtained in the same manner as in Example 1, except that the molar ratio of LaF₃, SrF₂, and SrS was changed as presented in Table 1, which also indicates the compositional formula of the obtained fluoride ion conductor.

### Examples 3 to 6

Fluoride ion conductors were obtained in the same manner as in Example 1, except that the molar ratio of LaF₃, SrF₂, and SrS was changed as presented in Table 1, and only the second pellet of φ5 mm was formed. Table 1 also indicates the compositional formulas of the obtained fluoride ion conductors.

TABLE 1

| | | Compositional formula of |
|---|---|---|
| | LaF₃:SrF₂:SrS | fluoride ion conductor |
| Example 1 | 0.5:0.5:2.2 | La_{0.5}Sr_{2.5}F_{2.5}S₂ |
| Example 2 | 0.6:0.4:2.2 | La_{0.6}Sr_{2.4}F_{2.6}S₂ |
| Example 3 | 0.7:0.3:2.2 | La_{0.7}Sr_{2.3}F_{2.7}S₂ |
| Example 4 | 0.8:0.2:2.5 | La_{0.8}Sr_{2.2}F_{2.8}S₂ |
| Example 5 | 0.9:0.1:2.5 | La_{0.9}Sr_{2.1}F_{2.9}S₂ |
| Example 6 | 1.0:0.0:2.8 | La_{1.0}Sr_{2.0}F_{3.0}S₂ |

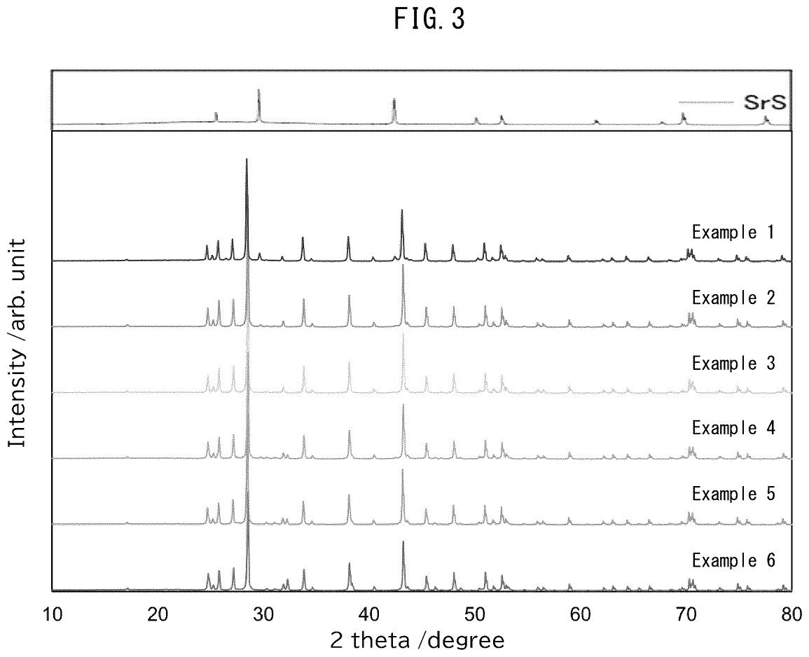

XRD patterns of the fluoride ion conductors of Examples 1 to 6 are presented in FIG. 3. FIG. 3 also indicates an XRD pattern of SrS as a raw material. As presented in FIG. 3, in Example 1, SrS was present as a by-product in the synthesized product in addition to the fluoride ion conductor. In contrast, in each of Examples 2 to 6, single-phase La₁₋ₓSr₂₊ₓF₃₋ₓS₂ was obtained in the crystal phase.

The XRD measurement was performed by a focusing method of irradiation with CuKα rays under conditions of a tube voltage of 40 kV and a tube current of 15 mA in an inert gas atmosphere using MiniFlex600-C available from Rigaku Corporation as an X-ray diffractometer. A glass sample holder was used as a substrate on which the sample was mounted.

### Comparative Example 1

A fluoride ion conductor was obtained in the same manner as in Example 1, except that LaF₃ and barium sulfide (BaS) as raw materials were weighed to have a molar ratio of LaF₃:BaS=7:3, and heat-treated at 950° C. for 24 hours. The obtained fluoride ion conductor was represented by a compositional formula La_{2.7}Ba_{6.3}F_{8.7}S₆.

### <<Evaluation>>

### <Impedance Evaluation>

On both surfaces of the fluoride ion conductor having a pellet shape with a diameter of φ10 mm in each of Examples 1 and 2 and Comparative Example 1, gold (Au) was deposited on the central portion of φ6 mm to form a current collector layer. Thus, a battery for evaluation was obtained. The battery was fixed by being sandwiched between stainless steel cylinders from both sides, and impedance evaluation was performed using VSP-300 available from Bio-Logic.

Au deposition was performed on the entire both surfaces of the fluoride ion conductor having a pellet shape of φ5 mm in each of Examples 2 to 6 and Comparative Example 1 to form a current collector layer. Thus, a battery for evaluation was obtained. The battery was fixed by being sandwiched between stainless steel cylinders from both sides, and impedance evaluation was performed using VSP-300 available from Bio-Logic.

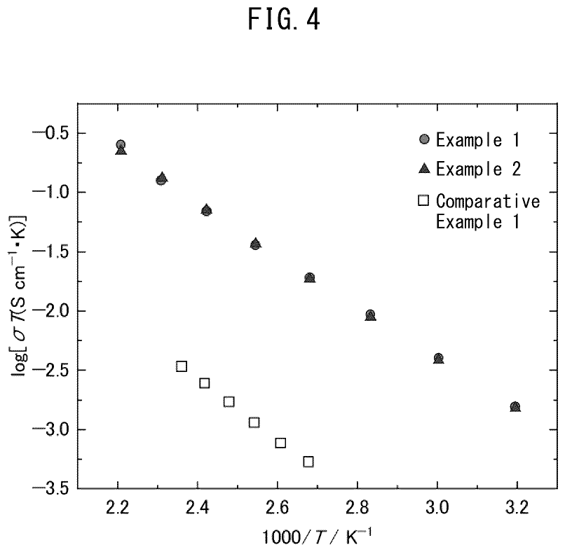

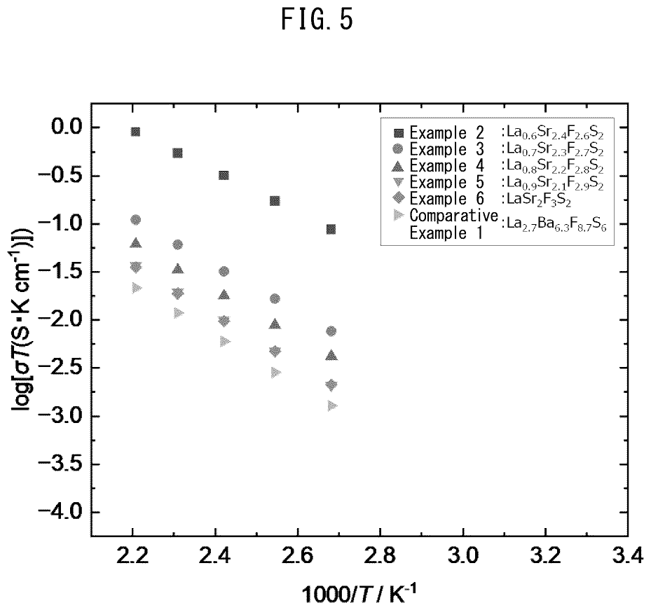

The results of the impedance evaluation of each Example are presented in FIGS. 4 and 5. As presented in FIGS. 4 and 5, the ionic conductivity of the fluoride ion conductor of each of Examples was higher than the ionic conductivity of the fluoride ion conductor of Comparative Example. This is assumed to be because the cation other than La is not Ba but Sr, and thus the diffusion path of the fluoride ion in the fluoride ion conductor of each of Examples is shorter than the diffusion path of the fluoride ion in the fluoride ion conductor of Comparative Example.

The fluoride ion conductor of Example 2 had particularly high ionic conductivity. This is assumed to be due to the fact that when x in the compositional formula La₁₋ₓSr₂₊ₓF₃₋ₓS₂ is 0.4, F vacancies contributing to the diffusion of fluoride ions are present at an appropriate proportion, and the synthesized product of Example 2 is a single-phase fluoride ion conductor containing no impurity such as SrS.

### REFERENCE SIGNS LIST

1 Fluoride ion battery
10 Positive electrode current collector layer
20 Positive electrode active material layer
30 Solid electrolyte layer
40 Negative electrode active material layer
50 Negative electrode current collector layer

1. A fluoride ion conductor,
wherein the fluoride ion conductor contains lanthanum, strontium, fluorine, and sulfur, and
wherein the fluoride ion conductor has a double honeycomb structure.

2. The fluoride ion conductor according to claim 1, wherein the fluoride ion conductor is represented by a compositional formula, La₁₋ₓSr₂₊ₓF₃₋ₓS₂.

3. The fluoride ion conductor according to claim 2, wherein x in the compositional formula satisfies 0≤x≤0.5.

4. The fluoride ion conductor according to claim 3, wherein x in the compositional formula satisfies 0.2≤x≤0.4.

5. A fluoride ion battery, including, in this order, a positive electrode active material layer, a solid electrolyte layer, and a negative electrode active material layer,
wherein at least one selected from the positive electrode active material layer, the solid electrolyte layer, and the negative electrode active material layer contains the fluoride ion conductor according to claim 1.
